(19) United States
(12) Patent Application Publication
(10) Pub. No.: US 2008/0170260 A1
(43) Pub. Date: Jul. 17, 2008

(54) Output transform brokerage service

(76) Inventors: Michael Haller, Niwot, CO (US); James T. Smith, Boulder, CO (US); Joseph S. Czyszczewski, Longmont, CO (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 12/006,415

(22) Filed: Dec. 31, 2007

Related U.S. Application Data
(63) Continuation-in-part of application No. 10/689,126, filed on Oct. 20, 2003.
Application No. 10/689,126 is a continuation-in-part of application No. 10/380,834, filed on Mar. 19, 2003, now abandoned.

(51) Int. Cl. G06F 9/46

(52) U.S. Cl. 358/1.15

(57) ABSTRACT

A method for providing computer services is provided. The method includes receiving deployments of common standards transform services from each of one or more transform service providers, registering each deployment as a transform service provider, receiving a request for a transform service from a customer, matching the requested grid service with a deployment, linking the customer with a provider of the matched registered deployment and the provider performing a transform on data provided by the customer.

This is a Continuation in Part Application of application Ser. No. 10/689,126 filed Oct. 20, 2003, and application Ser. No. 10/380,834 filed May 26, 2006, and claims priority thereof.

### FIELD OF INVENTION

An embodiment of the invention relates to providing computing services, and more specifically, to providing web and grid-based service tools.

### BACKGROUND

Current offerings for transforming data streams into printable formats typically require that customers purchase a server solution that the customer maintains and operates. However systems have been proposed that include a mechanism for customers to leverage an on-line service for purchasing additional compute resources from an on-line service.

Nonetheless, there are various customers that prefer to operate their own resources that are sufficient to handle their peak loads. Moreover, such customers are unwilling to export tasks outside of their enterprise via an On-line Transform Service. However these customers may be interested in making their existing surplus transform capacity available as an on-line service where the customer is the provider of the service rather than a consumer of the service.

Such a mode incurs a problem in situations where potential customers to an on-line service require a single location for discovering the service, as well as being able to harness multiple providers in order to acquire enough processing power to meet their computing needs.

As a result, an inter-enterprise on-line service utility is desired that is capable of scaling to a volume of service request that allows a required level of output workflow to be delivered to each customer.

### SUMMARY

According to one embodiment, a method for providing computer services is disclosed. The method includes receiving deployments of common standards transform services from each of one or more transform service providers, registering each deployment as a transform service provider, receiving a request for a transform service from a customer, matching the requested grid service with a deployment, linking the customer with a provider of the matched registered deployment and the provider performing a transform on data provided by the customer.

### BRIEF DESCRIPTION OF THE DRAWINGS

The invention may be best understood by referring to the following description and accompanying drawings that are used to illustrate embodiments of the invention. In the drawings:

FIG. 1 is a block diagram of one embodiment of a system;

FIG. 2 is a block diagram of one embodiment of a transform mechanism; and

FIG. 3 is a block diagram illustrating one embodiment of a resource context.

### DETAILED DESCRIPTION

A transform brokerage service is disclosed. According to one an embodiment, the service includes service providers to transform data from a first format to a second format, customers to request the transform of data and a transform services broker, having a registry of each of the one or more transform service providers, to receive a request from a customer and to link the customer with a provider.

The brokerage service may be implemented through web services, grid services or a combination of the two. Web services are collections of procedures callable over the internet using standard protocols like HTTP and described to clients by a standard XML format known as Web Service Description Language (WSDL). Typically, a web service implementation may be deployed inside an existing web server, such as WebSphere®, using a web service toolkit. Moreover, a Java™-based web service may be deployed inside a servlet container which itself runs inside the web server. From a business perspective, utilizing a web service rather than traditional software offers several benefits. First, it provides a simplified mechanism for connecting applications regardless of technology or location. Second, web services are widely distributed and utilized and, subsequently, are based on industry standard protocols with universal support. Third, web services provide support for multiple connections and information sharing scenarios.

Grid services are enhanced web-services which simplify the deployment of complex distributed systems while simultaneously allow for decentralized maintenance and control. A computing grid is formed when disparate computers and systems in an organization—or among organizations—essentially become one large, integrated computing system: a virtual supercomputer. That system may then be applied to problems and processes too large and intensive for any single computer to easily handle alone in an efficient manner.

Building a grid is beneficial because the location of the computational resources is abstracted and transparent to the end-user. By establishing this abstraction and interconnection, the available computing power is nearly unlimited. In the case of print workflow as provided by the present invention, the scalability causes that the speed of the print engine to become the deciding factor of possible impressions per minute (i.e. bottleneck), not the software or hardware. PCs and Windows servers may be only about five percent utilized, Unix Servers may be only about fifteen percent utilized, and mainframes may only be about sixty-five percent utilized. A grid solution brings together these untapped resources to boost computer capacity, meaning less hardware is needed and ROI on current hardware increases.

In the following description, numerous details are set forth. It will be apparent, however, to one skilled in the art that embodiments of the present invention may be practiced without these specific details. In other instances, well-known structures, devices, and techniques have not been shown in detail, in order to avoid obscuring the understanding of the description. The description is thus to be regarded as illustrative instead of limiting.

Reference in the specification to “one embodiment” or “an embodiment” means that a particular feature, structure, or characteristic described in connection with the embodiment is included in at least an embodiment of the invention. The appearances of the phrase “in one embodiment” in various places in the specification are not necessarily all referring to the same embodiment.

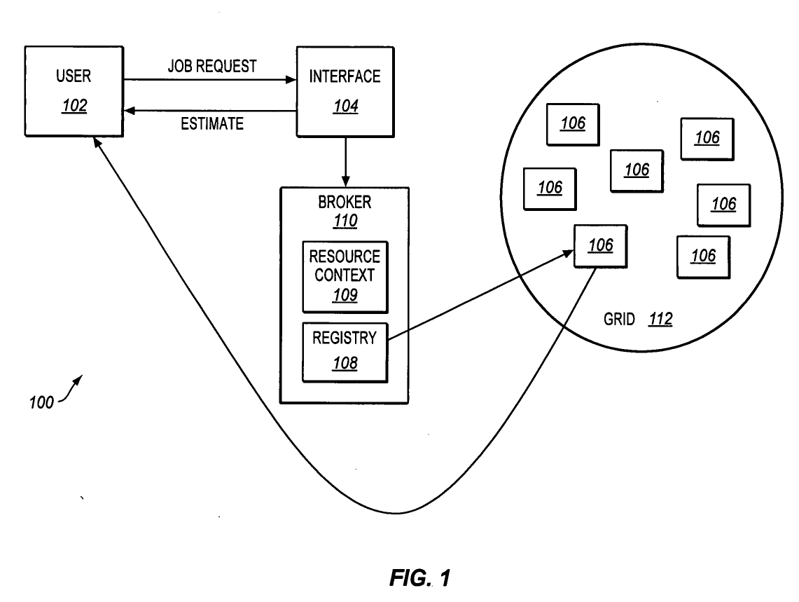

FIG. 1 is a block diagram of one embodiment of a system 100. System 100 is a grid-based system including providers 106 within a grid 112. In one embodiment, providers 106 register unused computing capacity to perform services with a registry 108 within a broker 110. Users 102 at client computers submit job requests through an appropriate interface 104 to the broker 110. In one embodiment, users 102 are clients that may include printers, display devices, computers, applications, etc.

According to one embodiment, the broker 110 matches job requests with providers 106. In this embodiment, providers 106 deploy a common standards based interface, such as a developing transform service interface to their deployed transforms. Each provider 106 deployment of a service subsequently registers as a provider of the grid service 112 with broker 110 of service.

Broker 110 provides the same grid service interface 104 to users 102 looking to utilize a service. Broker 110 may then schedule incoming work to any of the registered services tracking how much service was provided by each provider in the grid, and providing compensation for providing the service to the Grid. Additionally broker 110 may charge a brokerage fee on top of each transaction passing through.

In a further embodiment, the ultimate provider(s) 106 may be unknown to the user 102 which is purchasing computing power. In a further embodiment, a provider may itself also be a user and may purchase capacity from broker 110 during times of high utilization. Moreover, a provider 106 may sell excess capacity during times of low utilization, thereby reducing wasted resources.

The use of services provided through broker 110 may optimize service capacity and utilization of the components of the present invention across users. The service-based workflow framework of the present invention utilizes grid services and intrinsically defines a mechanism for linking customer-deployed services to broker 110. This system of provider transparency creates an online marketplace and a virtual industry for the purchase and exchange of software services offered in a collaborative and transient grid (e.g., grid 112).

Thus, broker 110 serves as an intermediary, a central distributor and scheduler of grid services. Providers 106 may deploy common standards-based grid services and register as a provider of service with a broker owned service. The broker 110 provides the same grid service interface to its customers looking to utilize a service. The broker then is able to schedule incoming work to any of the registered services while tracking how much service was supplied by each provider 106 on the grid 112. The service provider 106 may receive compensation for the usage of its grid node and the broker 110 may receive a brokerage fee for each transaction it facilitates.

In one embodiment, broker 110 enables flexible and affordable pricing for participant users of all sizes. Moreover, service level agreements may be used to manage performance so a large enterprise with high usage is provided a consistent level of price-performance with a small enterprise. Thus, a user 102 pays a provider 106 for only the capacity needed, and only when needed.

Broker 110 includes registry 108 and resource context 109, which will be discussed in further detail below. Registry 108 stores relevant data about the structure of grid 112, including information that enables the grid 112 to expand and contract seamlessly. In one embodiment, registry 108 is backed by a distributed database, ensuring that it is not a potential single point of failure. Registry 108 may be integrated into the broker 140 or may be external. In fact, registry 108 may itself be a grid service.

According to one embodiment, providers 106 are not statically recorded in registry 106. Thus, providers 106 may come and go dynamically from grid 112. Through this seamless registration and discovery mechanism service agreements can be put in place to ensure that individual providers 106 may be reimbursed for any processing that they perform on behalf of grid 112. In so doing this enables a heterogeneous collection of providers 106 to resell capacity to consumers on demand.

As discussed above, providers 106 provide services to users 104 through broker 110. In one embodiment, a variety of transform service levels may be supported to enable customers to choose how much a desired capacity in order to match the requirements of each transform job.

A transform provider 106 may transform the format of received data from a user application for presentation or consumption. For instance, a transform may apply stylesheets or other formatting properties to the data (e.g., fonts, templates, Extended Markup Language Stylesheet (XSL). Further, the user 102 receiving the transformed data may consume the data (e.g., using or saving), instead of presenting the data. Additionally, a transform provider 106 may transform data from one presentation or consumption format, e.g., PostScript, to another, such as PCL.

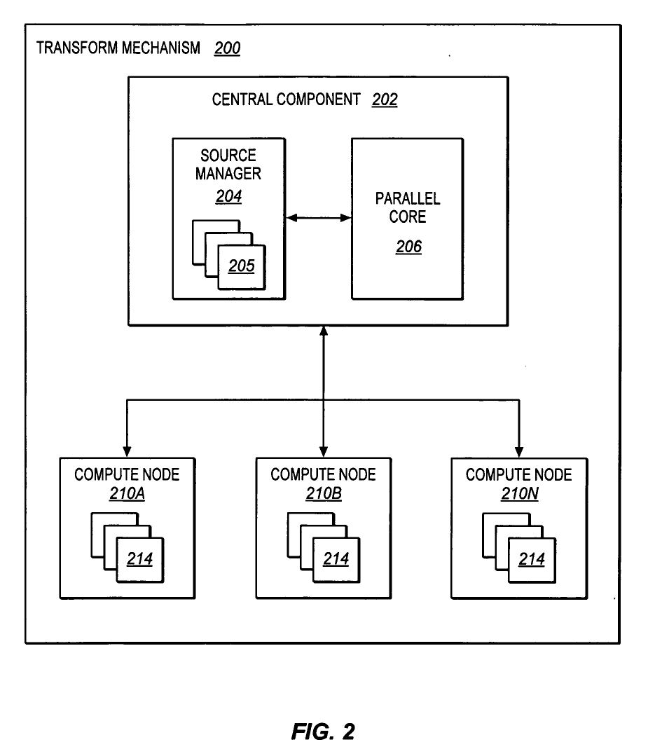

FIG. 2 illustrates one embodiment of a transform mechanism 200 implemented at a provider 106. Transform mechanism 200 includes a central component 202 and a cluster of compute nodes 210a-210n. Central component 202 includes a source manager 204 coupled to a parallel core 206. Central component 202 is coupled to the cluster of compute nodes 210a-210n. Each compute node 210a-210n includes and loads one or more data stream transforms 214 preferably as dynamic libraries, e.g., plug-ins. According to one embodiment, central component 202 manages data stream independent functions and compute nodes 210a-210n handle the data stream processing, e.g., transformation.

Source manager 204 includes a plurality of sources 205, where each source 205 is a unit of one or more processing threads that accepts data and/or commands from an external interface. Each source 205 may be associated with and accepts a particular data stream format and handles format-specific operations.

During operation a provider 106 receives a request from a user 102 via broker 110 to transform a data stream. Source manager 204 receives the request and determines which source 205 to instantiate (e.g., by examining a signature in the request). The signature may explicitly identify a particular source or it can indicate where the source is located (e.g., “load source mypath/myprogram.lib.”). For instance, if the received request calls for a data stream transformation from PDF to AFP, the source manager 204 identifies and loads the PDF source 205a, preferably as a dynamic library.

In one embodiment, each source 205 is associated with one or more transforms 214. For example a source that handles a PPML data stream includes PostScript, PDF, TIFF and JPEG transforms. Once instantiated, source 205a requests that the associated transform(s) 214a be loaded by the cluster of computer nodes 210a-210. Once transforms 214a are loaded, source 205a begins accepting data and commands from the user 102. Source 205a parses the information into a stream of work units. Each work unit is designed to be independent of other work units in the stream. As an independent unit of work, the work unit includes all information needed to process the work unit.

Work units may include data and control. The data work unit includes actual data to be processed. A data work unit can be either complete or incremental. A complete work unit includes all the data needed to process the work unit. An incremental work unit includes all the control data but not the data to be processed. If a work unit is incremental, the compute node, e.g., 210a, will call a “get data” API provided by the source 205 to obtain more data. The API will indicate that compute node 210a has all the data for the work unit by setting the appropriate return code.

A control work unit includes commands for compute nodes. Control work units may either apply to all or some compute nodes. These work units are generated indirectly by sources 205 (e.g., a source 205 calls a particular command API which then generates and issues an appropriate control work unit).

After parsing the data into work units, source 205a submits the work units to parallel core 206. After parallel core 206 receives the work units, it schedules and distributes the work units to different compute nodes 210a, 210b for processing. Parallel core 206 maintains queues of work units from which the compute nodes 210a, 210b obtain the next available work unit. While a variety of scheduling algorithms can be used that are well known in the art, a simple first-in-first-out scheme is utilized in one embodiment.

Subsequently, each compute node 210a, 210b transforms (e.g., processes) the work unit. The processed work units are returned to parallel core 206. As each compute node 210a completes its current work unit, it takes the first queued work unit and continues processing.

The work units are often completed out of order. Accordingly, parallel core 206 collects the processed work units and, if needed, sequences the processed work units in the proper order before returning them to the source 205a. In another embodiment, as each compute node 210a, 210b processes the work unit, the processed data is cached for return to parallel core 206. Parallel core 206 instructs each compute node 210a, 210b when to start sending the cached data so that it receives the processed work units in proper order. In this embodiment, a processed work unit may be cached, while compute node 210a begins processing a next work unit. In addition to the processed data, the parallel core 206 also returns error, status, log and trace information to the source 205a.

Finally, source 205a returns the transformed DataStream back to the user. Once source 205a has completed its task (e.g., the connection from the user is closed, and the transforms 214a implemented by the source 205a are unloaded if no other source requires them.

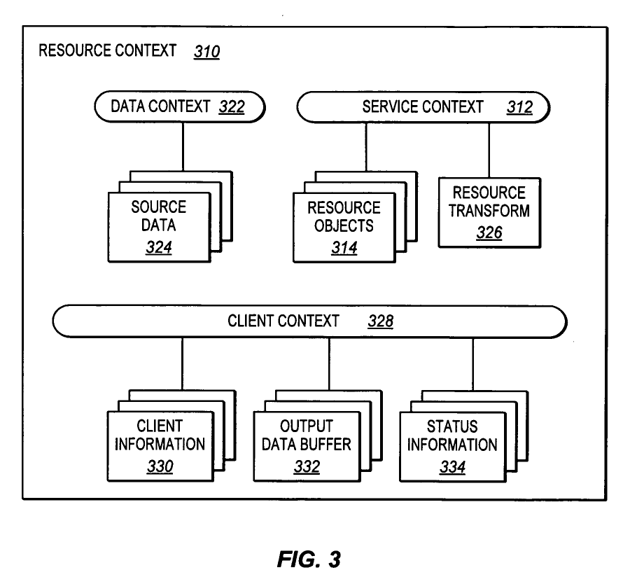

According to one embodiment, resource context 109 within broker 110 may be implemented to broker the services between a user 102 and a provider 106. FIG. 3 illustrates one embodiment of resource context 310. Resource context 310 includes a service context 312 that includes classes and methods to handle a request from a transform mechanism 200 and initialize a resource object 314 for an instance of a transform mechanism 200. The resource object 314 maintains availability of source data and resources needed by the transform mechanism 200. For instance, the resource object 314 may maintain the actual source data and resources needed by the transform mechanism 200 or maintain references to the source data and resources that the transform mechanism 200 may use to access.

Service context 312 may initialize one or more resource objects 314 for each instantiated instance of a transform mechanism 200 performing a particular transform. The transform mechanism 200 may require resources 314, such as fonts, stylesheets, templates, functions or other information or code used in the course of transforming source data 324 from one format to another. The call from transform mechanism 200 to service context 312 may identify the source data 324 and resources 314 to obtain and the type of transform. The service context 312 may then call specific methods for the type of transform requested to acquire the appropriate resources 314 (or references thereto), which may require the service context 312 to access resources 314 from a remote location over a network using suitable remote access procedures known in the art, e.g., remote procedure calls, web services. Additionally, service context 312 may maintain reference information that the transform mechanism 200 may use to access the resources 316 from the remote location.

The service context 312 may further call a data context 322, which includes classes and methods to access the source data 324 or provide a reference to the source data 324. The data context 322 may maintain the accessed source data 318 as source data 324 in a local storage that it may provide to the transform mechanism 200. Further, the data context 322 may serve as a conduit or a referential source, such that the data context 322 maintains a reference to the source data without storing the source 324 locally.

The source data 324 may be maintained separately or with the resource objects 314 to make available to the transform mechanisms 200. The service context 312 may additionally call a resource transform 326 which performs a transformation on an accessed resource 316 to maintain in the resource object 314 for a transform mechanism 200. Additionally, the resource transform 326 may generate the resource that the transform mechanism 200 requires. For instance, if the resource comprises a font or stylesheet, then the resource transform 326 may generate that resource without having to access the resource 316 remotely over the network.

The resource context 310 further includes a client context 328 having classes and methods that transform mechanism 200 invokes to transmit output generated from the transform mechanism 200 to one or more of the users 102.

Client context 328 maintains client information 330 for each user 102 to which the output may be transmitted. The client information 328 may specify a presentation or consumption format for the output so that the output may be transformed to conform to the output capabilities of the target user 102. Alternatively, all such data format transformations may be performed by transform mechanism 200 and not the client context 328. Client information 330 may additionally specify a communication method for transmitting the output over the to the user 102.

The communication method may indicate a transmission protocol and transmission technique, e.g., streaming settings, transmission speed, packet size, packet buffer settings, etc. In one embodiment, transform mechanism 200 may transform the format of the data for the user 102. Alternatively, client context 328 may use client information 330 for a particular client to transform the format the output of the data. For instance, if the user 102 comprises a small hand held computer device, such as a personal digital assistant, accessible over a wireless network, the output may be transformed into an output format compatible with a small hand held computer screen.

Alternatively, if the user 102 includes a more powerful computer with substantial graphics capabilities, then output may be transformed into an output suitable for a computer having significant graphics capabilities. Client context 328 may further use communication methods in the client information 330 to format the output for transmission over a particular type of network used by the user 102, e.g., wireless, high speed network, etc. Client context 328 may maintain a separate buffer 332 to store and buffer transformed output data to transmit or stream to the user 102. One buffer 332 may be maintained for each transform mechanism 200 instance utilizing the resource context 310 services.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A method for providing computer services, comprising:
receiving deployments of common standards transform services from each of one or more transform service providers;
registering each deployment as a transform service provider;
receiving a request for a transform service from a customer;
matching the requested grid service with a deployment;
linking the customer with a provider of the matched registered deployment; and
the provider performing a transform on data provided by the customer.

2. The method of claim 1 further comprising the customer receiving the transformed data from the provider.

3. The method of claim 1 wherein performing the transform on data provided by the customer comprises a resource context acquiring the data and resources to perform the transform.

4. The method of claim 3 wherein performing the transform further comprises transforming each unit of data from a first format to a second format.

5. The method of claim 1 wherein the customer is a provider requesting additional transform capacity.

6. The method of claim 1 wherein deployments of common standards transform services are provided as grid-based services.

7. The method of claim 1 wherein deployments of common standards transform services are provided as web-based services.

8. A network, comprising:
one or more service providers to transform data from a first format to a second format;
one or more customers to request the transform of data; and
a transform services broker, having a registry of each of the one or more transform service providers, to receive a request from a customer and to link the customer with a provider.

9. The network of claim 8 wherein the broker comprises a resource context to acquire the data and resources to perform the transform of data.

10. The network of claim 8 wherein the one or more service providers are provided as grid-based services.

11. The network of claim 8 wherein the one or more service providers are provided as web-based services.

12. A computer program product of a computer readable medium usable with a programmable computer, the computer program product having computer-readable code embodied therein for providing computer services, the computer-readable code comprising instructions for:
receiving deployments of common standards transform services from each of one or more transform service providers;
registering each deployment as a transform service provider;
receiving a request for a transform service from a customer;
matching the requested grid service with a deployment;
linking the customer with a provider of the matched registered deployment; and
the provider performing a transform on data provided by the customer.

13. The computer program product of claim 12 further comprising instructions for the customer receiving the transformed data from the provider.

14. The computer program product of claim 12 wherein performing the transform on data provided by the customer comprises a resource context acquiring the data and resources to perform the transform.

15. The computer program product of claim 14 wherein performing the transform further comprises transforming each unit of data from a first format to a second format.

16. The computer program product of claim 12 wherein the customer is a provider requesting additional transform capacity.

18. The computer program product of claim 12 wherein deployments of common standards transform services are provided as grid-based services.

19. The computer program product of claim 12 wherein deployments of common standards transform services are provided as web-based services.

19. A broker server, comprising:
an input to receive customer requests to transform data from a first format to a second format;
a registry of transform service providers implemented to perform a transform; and
an output to forward a transform request to one or more of the transform service providers.

20. The broker server of claim 19 further comprising a resource context to acquire the data and resources to perform the transform of data.
